(19) United States
(12) Patent Application Publication
(10) Pub. No.: US 2015/0007197 A1
(43) Pub. Date: Jan. 1, 2015

(54) MAPPING APPLICATION DEPENDENCIES AT RUNTIME

(71) Applicants: Travis S. Tripp, Fort Collins, CO (US); Heather L. Whisenhunt, Fort Collins, CO (US); Erik Colnick, Longmont, CO (US); Kurt E. Spence, Fort Collins, CO (US); Peir Fiedler, Uvaly, Prague (CZ); Jan Vana, Trebon (CZ); Kevin L. Wilson, Fort Collins, CO (US)

(72) Inventors: Travis S. Tripp, Fort Collins, CO (US); Heather L. Whisenhunt, Fort Collins, CO (US); Erik Colnick, Longmont, CO (US); Kurt E. Spence, Fort Collins, CO (US); Peir Fiedler, Uvaly, Prague (CZ); Jan Vana, Trebon (CZ); Kevin L. Wilson, Fort Collins, CO (US)

(21) Appl. No.: 14/375,039

(22) PCT Filed: Apr. 27, 2012
(86) PCT No.: PCT/US2012/035450

§ 371 Date: Jul. 28, 2014

(51) Int. Cl. G06F 9/46

(52) U.S. Cl. CPC G06F 9/46
USPC 718/106

(57) ABSTRACT

Systems, methods, and machine-readable and executable instructions are provided for mapping application dependencies. Mapping application dependencies can include defining an application model with a number of application dependencies that enables an application to run and defining a platform model that defines a number of capabilities that are provided by a server. Mapping application dependencies can also include creating a topology model that maps the application model to the platform model at runtime by mapping the number of application dependencies to the number of capabilities while the application remains independent from the server.

### BACKGROUND

Cloud services, be it private or public clouds, are gaining momentum. Maintaining availability of applications running on cloud systems and other types of systems is important. Hybrid cloud systems are becoming increasingly popular as private cloud systems seek to expand into public cloud functionality. The binding of private cloud systems to public cloud systems can affect the availability of applications running on the hybrid cloud system.

### BRIEF DESCRIPTION OF THE DRAWING

FIG. 1 illustrates an example of a hybrid cloud system implemented using a topology model according to the present disclosure.

FIG. 2 illustrates an example of a deployment stack according to the present disclosure.

FIG. 3 illustrates an example of application dependency mapping according to the present disclosure.

FIG. 4 illustrates an example of tag resolving at deployment time according to the present disclosure.

FIG. 5 is a flow chart illustrating an example of a method for mapping application dependencies at runtime according the present disclosure.

FIG. 6 illustrates a block diagram of an example of a machine-readable medium in communication with processing resources for mapping application dependencies at runtime according to the present disclosure.

### DETAILED DESCRIPTION

Examples of the present disclosure may include methods and systems for mapping application dependencies at runtime. An example method for mapping application dependencies at runtime may include defining an application model with a number of application dependencies that enables an application to run and defining a platform model that defines a number of capabilities that are provided by a server. An example method for mapping application dependencies at runtime can also include creating a topology model that maps the application model to the platform model at runtime by mapping the number of application dependencies to the number of capabilities while the application remains independent from the server.

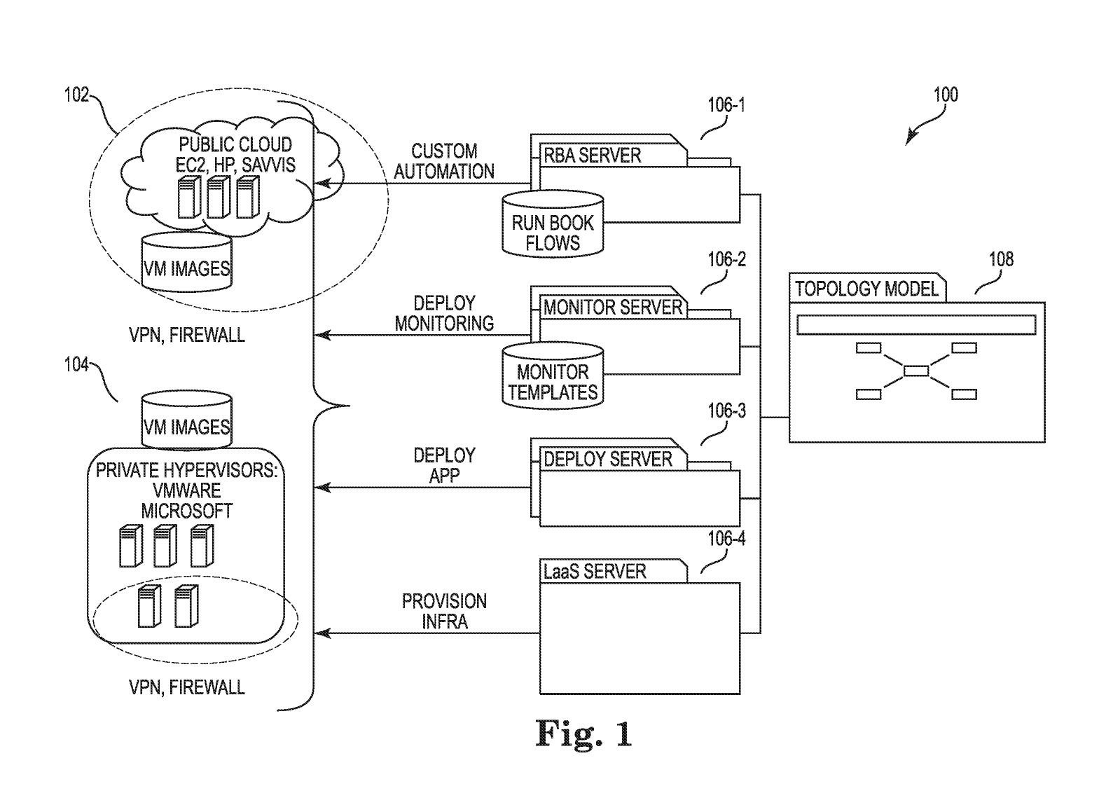

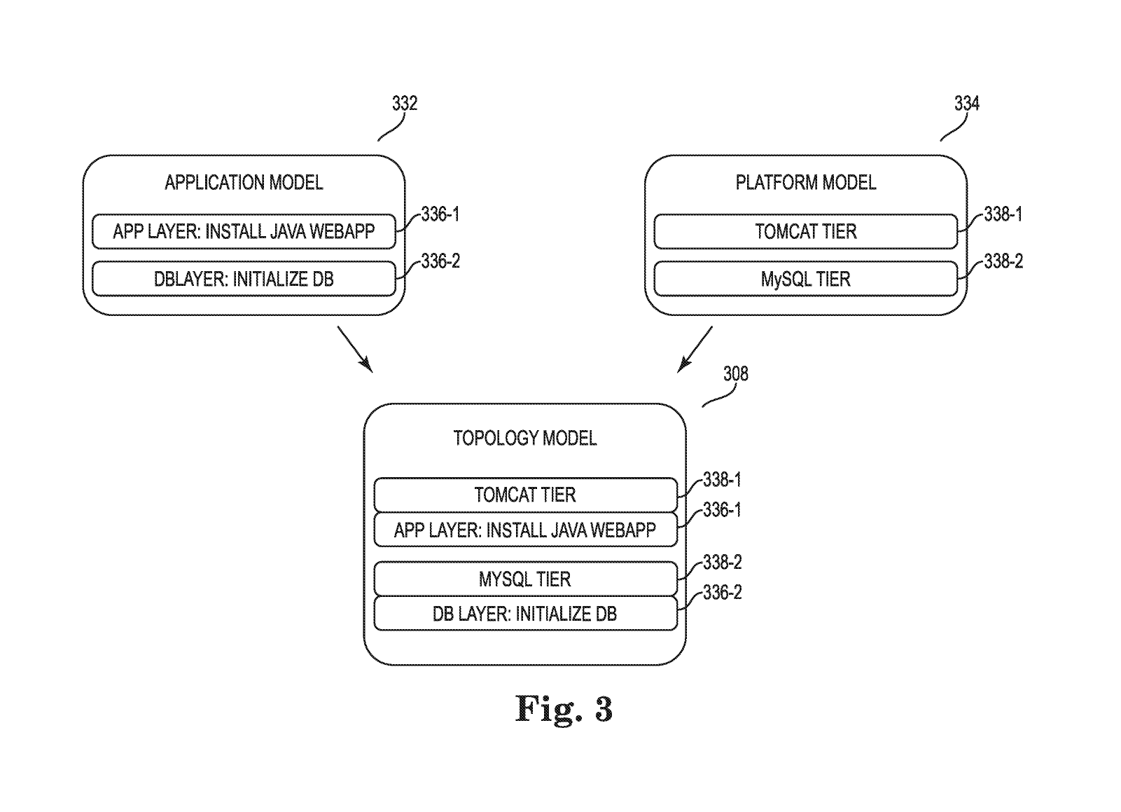

The figures herein follow a numbering convention in which the first digit or digits correspond to the drawing figure number and the remaining digits identify an element or component in the drawing. Similar elements or components between different figures may be identified by the use of similar digits. For example, 108 may reference element “08” in FIG. 1, and a similar element may be referenced as 308 in FIG. 3.

As used herein, “a” or “a number of” something can refer to one or more such things. For example, “a number of widgets” can refer to one or more widgets.

Hybrid could systems can combine two or more cloud systems. For example, a hybrid cloud system can combine a private cloud system and a public cloud system. A public cloud system can include a cloud system that makes applications, storage, and/or other resources available to the general public through a service provider. A private cloud system can include a cloud system that is operated solely by one entity for the use of that entity.

A hybrid cloud system can combine two or more cloud systems by combining the resources of the two or more cloud systems. For example, a hybrid cloud system can combine the hardware resources of a private cloud system with the monitoring resources of a public cloud system.

Hardware resources and software resources associated with a first cloud system can limit the use of an application in a second cloud system. For example, if a first cloud system is associated with a first operating system (OS), then a second cloud system can only use monitoring resources, e.g., application, that are compatible with the second cloud system. In a number of examples of the present disclosure, a hybrid cloud system can combine two or more cloud systems that are independent of each other without limiting the use of an application.

FIG. 1 illustrates an example of a hybrid cloud system implemented using a topology model according to the present disclosure. Hybrid cloud system 100 can include public cloud system 102 and private cloud system 104.

A public cloud system 102 can include a number of capabilities. For example, a public cloud system 102 can include an run book automation (RBA) server 106-1 and a monitor server 106-2. An RBA server 106-1 can define, build, orchestrate, manage and report on workflow, e.g., capabilities. Additionally an RBA server 106-1 can customize automation of a system. A monitor server 106-2 can manage a number of objects. For example, a monitor server 106-2 can manage an application, a server, and/or any other objects from which the monitor server can receive a number of messages.

A private cloud 104 can include a number of capabilities. For example, a private cloud can include a deploy server 106-3 and an infrastructure as a service (IaaS) server 106-4. A deploy server 106-3 can deploying an application, e.g., capabilities. An IaaS server 106-4 can include the capability of provisioning system infrastructure.

A server can include any system that provides or requests a number of resources. A server can include a hardware infrastructure. A server can also include a software infrastructure. Capabilities associated with a server can reference the services and/or resources that a server can provide. A server can provide services and/or resources through a hardware infrastructure associated with a server and/or through a software infrastructure associated with a server.

A number of capabilities can also include properties associated with a server. Disclosing properties can include providing a number of parameters associated with a server. The parameters can include parameters that originate with a first server that provides specific capabilities or parameters that originate with a second server that does not provide the specific capabilities. For example, a first server that is hosting a webpage can query a second server for a port number. The second server can provide the port number to the first server. The first server can then provide the port number, e.g., parameter, to an application regardless of where the port number originated. That is, the first server can provide a capability regardless of where the port number, e.g., capability, originated.

In a number of examples of the present disclosure, a topology model 108 can allow an application to use the capabilities of the public cloud system 102 and the private cloud system 104. That is, a topology model 108 can facilitate interactions between the different servers in the public cloud system 102 and the private cloud system 104 without requiring an application to be configured to any particular system.

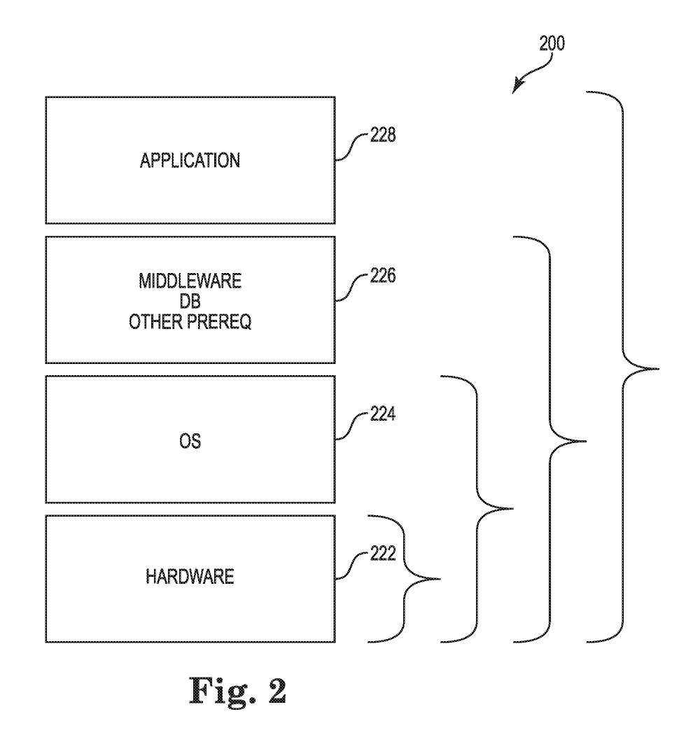

FIG. 2 illustrates an example of a deployment stack according to the present disclosure. A deployment stack 220 can include a hardware stack 222, an OS stack 224, a middleware stack 226, and/or an Application stack 228. A deployment stack 220 can include more or less stacks. Furthermore, a deployment stack 220 can include different stacks that convey other functionalities. For example, a deployment stack 220 can include multiple applications that share application stack 228.

A hardware stack 222 can include hardware infrastructure. Hardware infrastructure can include a number of hardware components that are associated with computing. For example, hardware infrastructure can include a physical server, a physical network, a processor, memory, and/or any number of hardware components that assist in computing. Hardware infrastructure can include more or less components than those listed. Hardware infrastructure can also include a hardware infrastructure that is simulated in software. For example, hardware infrastructure can include hardware virtualization. Hardware virtualization simulates a hardware infrastructure, e.g., a simulated computer environment.

An OS stack 224 can include a number of OSs that run on a hardware system, e.g., hardware infrastructure. An OS can provide a number of basic services to an application. The basic services can provide access to hardware infrastructure. However, an OS is not limited to basic services and can include a number of services.

Middleware stack 226 can include middleware. Middleware includes software that provides services to an application beyond those provided by the OS stack 224. For example, middleware can include a number of applications, libraries, and/or configurations that provide services and/or resources to an application beyond those provided by a hardware stack 222 and/or an OS stack 224.

An application stack 228 can include a number of applications. A number of applications can include applications that are supported by the middleware stack 226, the OS stack 224, and/or the hardware stack 222. In a number of examples of the present disclosure, an application stack 228 can include applications that can be categorized as middleware. For example, an application such as a web hosting application, can under a first set of circumstances, be categorized as middleware because it can provide service and/or resources to a different application. However, an application such as a web hosting application can, under a second set of circumstances, be categorized as a standalone application because the web hosting application can depend on middleware.

A deployment stack 220 can define a number of dependencies between sub-stacks, e.g., a hardware stack 222, an OS stack 224, a middleware stack 226, and/or an application stack 228. For example, a deployment stack 220 can define the dependencies that an OS in an OS stack 224 can have on hardware infrastructure in a hardware stack 222. A deployment stack 220 can also define a number of dependencies that middleware in a middleware stack 226 can have on an OS and/or on hardware infrastructure. Moreover, a deployment stack 220 can define a number of dependencies that an application in an application stack 228 can have on middleware, an OS, and/or hardware infrastructure.

A deployment stack 220 can also define a number of dependencies within individual sub-stacks. For example, a first subset of hardware infrastructure can depend on a second subset of hardware infrastructure wherein the first subset of hardware infrastructure and the second subset of hardware infrastructure can be part of a hardware stack 222.

A deployment stack 220 can order the dependencies between sub-stacks and the dependencies within sub-stacks. An order of the dependencies can include a number of different orders and is not limited to a single methodology of ordering. In an example of the present disclosure, an order of the dependencies can include giving the hardware stack 222 dependencies a first priority, the OS stack 224 dependencies a second priority, the middleware stack 226 dependencies a third priority, and the application stack 228 dependencies a fourth priority.

FIG. 3 illustrates an example of application dependency mapping according to the present disclosure. A topology model 308, which can be analogous to topology model 108 in FIG. 1, can map a number of application model dependencies to a number of platform model capabilities at runtime.

An application model 332 can define a number of configuration units of an application and the dependencies of the number of configuration units. A number of configuration units can define a number of application layers that compose an application. For example, an application model 332 can include an application layer 336-1 and a database layer 336-2 (referred to generally as layers 336). An application layer 336-1 can define the core components of an application while a database layer 336-2 can define an interaction between the application and a database. The Layers 336 can define a number of dependencies between themselves. For example, an application layer 336-1 can depend on a database layer 336-2. The Layers 336 can also define a number of dependencies outside of the application model 332.

A platform model 334 can describe an environment that can support a number of applications by providing a number of capabilities. A platform model can be composed of a number of tiers. A tier can include a configuration of servers that provides hardware infrastructure, an OS, and/or middleware capabilities. The servers within a tier can reside in a common network configuration. A number of tiers can include a number of different configurations of servers. For example, platform model 334 can include a tomcat tier 338-1 and a MySQL tier 338-2. A tomcat tier 338-1 can include the capabilities of hosting a web application. A MySQL tier 338-2 can include the capabilities of initializing and managing a database. The capabilities that a tier provides can be provided by a configuration of servers at runtime. Furthermore, the capabilities that a tier provides can be provided after infrastructure provisioning, e.g., after runtime.

A topology model can provide the fulfillment of a number of application dependencies such that an application can be deployed on a specific tier, e.g., a configuration of servers. A topology model can be specific to a tier and an application. For example, a first topology model can map an application model to a first platform model and a second topology model can map an application to a second platform model wherein the first platform model and the second platform model can differ.

In FIG. 3, topology model 308 can map a dependency associated with an application layer 336-1 to a capability associated with a tomcat tier 338-1. For example, if the dependency is defined as the installation of a Java web application, then the Tomcat tier 338-1 can provide the capability of installing a java web application. Topology model 308 can map a dependency associated with a DB layer 336-2 to a capability associated with a MySQL tier 338-2. For example, if the dependency is defined as initializing a database, then a MySQL tier 338-2 can provide the capability of initializing a database.

A topology model 308 can fulfill the dependencies through the use of a deployment stack. The deployment stack can define an order in which dependencies can be fulfilled. For example, in an example of a deployment stack, an installation of a java web application dependency can be fulfilled before an initialization of a database dependency. Alternatively, an initialization of a database dependency can be fulfilled before an installation of a java web application dependency.

A topology model can map and fulfill a number of dependencies at runtime. In a number of examples of the present disclosure, runtime can include a time when an application initiates execution. In some examples, runtime can include an operation execution time. For example, an operation execution time can include a time at which an application is deployed.

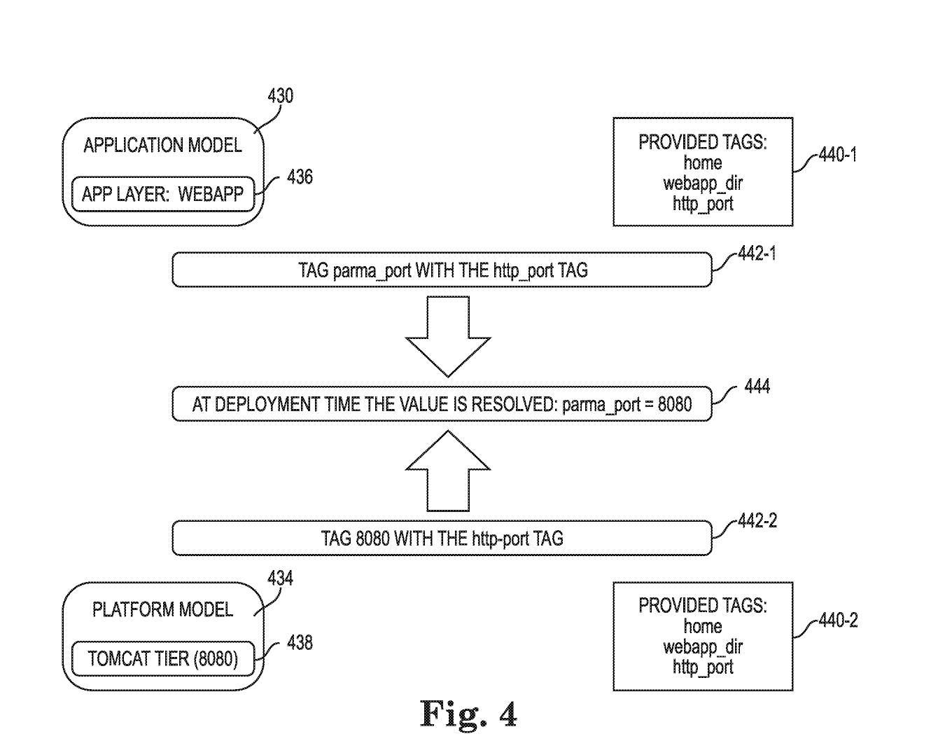

FIG. 4 illustrates an example of tag resolving at deployment time according to the present disclosure. An application model 432, which can be analogous to an application model 332 in FIG. 3, can define a number of dependencies through a number of tags 440-1. A platform model 434, which can be analogous to a platform model 334 in FIG. 3, can define a number of capabilities through the number of tags 440-1.

A tag can allow an application model to remain independent from a platform model. A tag can allow for the communication of dependencies and capabilities without requiring communication between an application and a tier. For example, a tag can allow an application model to be re-mapped to a number of platform models without changing the application model because the application is not configured to any specific tier.

When an application model places a tag on a dependency it can create a contract with a platform model. A platform model can guarantee the application model, e.g., the application layer, that a number of capabilities that are associated with a tag will be available at runtime, e.g., deployment time. A tag can allow an application layer to create a reference variable that references a capability, e.g., service and/or resource, that is provided by a platform model. A tag can allow a reference variable to reference a capability even though the application layer does not know where and/or how the capability will be fulfilled. A reference variable can be late binding. Late binding includes resolving a reference variable at runtime, e.g., deployment time and/or operation execution time. Furthermore, an application layer can reference parameters through a number of tags without being bound to a specific platform.

For example, an application layer 436 can tag 442-1 a reference variable Param_Port with an http_port tag. A tomcat tier 438 in platform model 434 can tag 442-2 a port number, e.g., 8080, representing a port. The application layer 436 can tag the reference variable Param_Port without being bound to a specific platform tier. The tags can be resolved at deployment time 444 by mapping a Param_Port reference variable that is tagged, e.g., http_port tag, to a port number 8080 that is tagged with a corresponding tag, e.g., http_port tag.

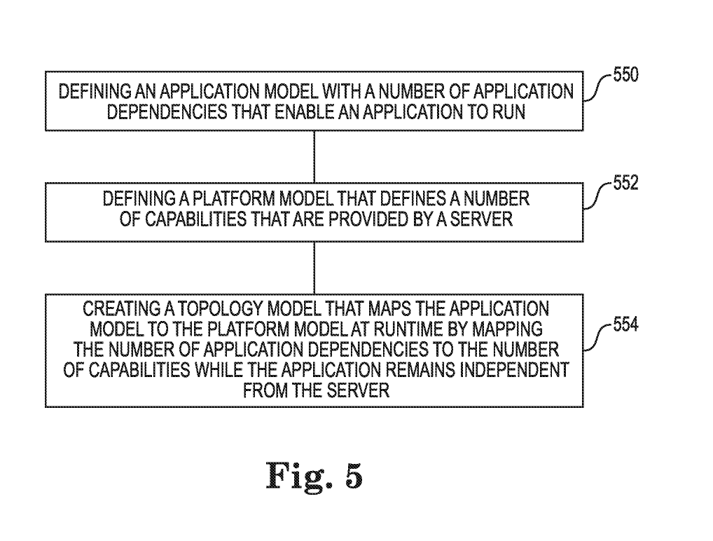

FIG. 5 is a flow chart illustrating an example of a method for mapping application dependencies at runtime according the present disclosure. At 550, an application model can be defined with a number of application dependencies that enable an application to run. At 550, a platform model can be defined a number of capabilities that are provided by a server. At 554, a topology model can be created, wherein the topology model can map the application model to the platform model at runtime by mapping the number of application dependencies to the number of capabilities while the application remains independent from the server.

In a number of examples of the present disclosure, an application model can be mapped to a platform model at run time. A mapping can include ordering a number of dependencies and resolving the dependencies at runtime. An application model can create a number of dependencies using a number of tags. Creating a number of dependencies through a number of tags can allow an application to remain independent of a server. The dependencies can be created through reference variables. A reference variable can be tagged without binding a reference variable to a specific server. The application can remain independent because the application can create dependencies without requiring the application to communicate with the server.

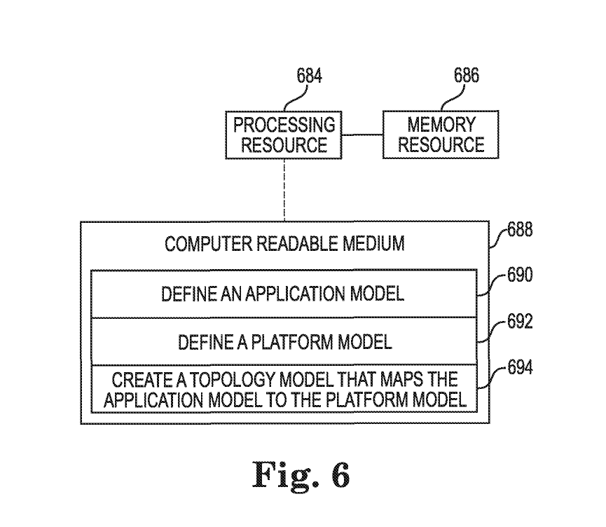

FIG. 6 illustrates a block diagram of an example of a computer-readable medium in communication with processing resources for platform runtime abstraction according to the present disclosure. The computer readable medium 688 (e.g., a tangible, non-transitory medium) and/or the memory resource 686 can store a set of instructions executable by the processing resource 684 to define 690 an application model. The instructions can be executed to define 692 a platform model. The instructions can be executed to create 694 a topology model that maps the application model to the platform model.

An application model can be defined 690 with a number of applications dependencies that enable a number of applications to run. The number of application dependencies that enable the number of applications to run can include application dependencies within the number of applications and application dependencies between the number of applications and a number of servers. A platform model can be defined 692 with a number of tiers that define a number of capabilities wherein a tier includes a group of servers. A tier can include a group of servers that have the same OS and the same middleware. A topology model can map the application model to the platform model by mapping the number of application dependencies to the number of capabilities while the application model remains independent form the platform model. The topology model can resolve the application dependencies by using a deployment stack. A deployment stack can define an ordering of the application dependencies wherein the ordering of the application dependencies can define an order in which the number of application dependencies can be resolved. A number of applications can define the priority of the dependencies. The priority of the dependencies can provide a basis for the ordering of the application dependencies. The topology model can create a mapping between the number of application dependencies and a number of capabilities that a platform model provides.

The methods, techniques, systems, and apparatuses described herein may be implemented in digital electronic circuitry or computer hardware, for example, by executing instructions stored in computer-readable storage media. Apparatuses implementing these techniques may include appropriate input and output devices, a computer processor, and/or a tangible computer-readable storage medium storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

Although the operations of the disclosed techniques may be described herein as being performed in a certain order and/or in certain combinations, in some implementations, individual operations may be rearranged in a different order, combined with other operations described herein, and/or eliminated, and the desired results still may be achieved. Similarly, components in the disclosed systems may be combined in a different manner and/or replaced or supplemented by other components and the desired results still may be achieved.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed:

1. A method for mapping application dependencies at runtime comprising:
defining an application model with a number of application dependencies that enables an application to run;
defining a platform model that defines a number of capabilities that are provided by a server; and
creating a topology model that maps the application model to the platform model at runtime by mapping the number of application dependencies to the number of capabilities while the application remains independent from the server.

2. The method of claim 1, wherein creating the topology model that maps the application model to the platform model at runtime includes mapping the application model to a platform model when the application initiates execution.

3. The method of claim 1, wherein the application remains independent from server includes the topology model resolving the application dependencies without requiring the application to communicate with the server.

4. The method of claim 3, wherein topology model resolves the application dependencies by providing a number of values to a number of reference variables that are used by the application to reference the number of capabilities.

5. A non-transitory computer-readable medium storing instructions for mapping application dependencies at runtime executable by a computer to cause the computer to:
define an application model with a number of application dependencies that enable a number of applications to run;
define a platform model with a number of tiers that define a number of capabilities wherein a tier includes a group of servers; and
create a topology model that maps the application model to the platform model at runtime by mapping the number of application dependencies to the number of capabilities while the application model remains independent from the platform model.

6. The medium of claim 5, wherein the number of application dependencies that enable the number of applications to run include application dependencies within the number of applications and application dependencies between the number of applications and a number of servers that define the number of tiers.

7. The medium of claim 5, wherein the topology model that maps the application model to a platform model at runtime resolves the application dependencies using a deployment stack.

8. The medium of claim 7, wherein the deployment stack includes an ordering of the application dependencies wherein the ordering of the application dependencies defines an order in which the number of application dependencies are resolved.

9. The medium of claim 5, wherein the topology model includes a mapping between the number of application dependencies and the number of tiers.

10. The medium of claim 5, wherein the tier that includes the group of servers include a group of servers that have the same operating system (OS) and the same middleware.

11. An system that maps application dependencies at runtime, comprising:
define an application model with a number of requested parameters that enable a number of applications to run;
define a platform model that includes a number of tiers that include a number of server parameters wherein a tier includes a group of servers that provide the same operating system (OS) and the same middleware; and
create a topology model that maps the application model to the platform model at runtime by mapping the number of requested parameters to the number of server parameters through a number of tags while the application model remains independent from the platform model.

12. The system of claim 11, wherein the number of applications define a number of requested parameters by placing a number of dependencies on a platform that supports the platform model through a number of tags.

13. The system of claim 12, wherein the number of tags create a contract between the number of applications and a platform wherein the contract guarantees the number of applications that the number of server parameters that correspond to the requested parameters will be available at deployment.

14. The system of claim, 12 wherein the number of tags allows the number of applications to leverage a number platform specific properties that correspond to the platform through a number of reference variables.

15. The system of claim 11, wherein the reference variables are resolved at run time.
